(19) United States
(12) Patent Application Publication
(10) Pub. No.: US 2022/0359905 A1
(43) Pub. Date: Nov. 10, 2022

(54) BATTERY DESIGN FOR ELECTRIC VEHICLES

(71) Applicant: Michael A. VanderWal, Lisbon, OH (US)

(72) Inventor: Michael A. VanderWal, Lisbon, OH (US)

(21) Appl. No.: 17/739,544

(22) Filed: May 9, 2022

Related U.S. Application Data
(60) Provisional application No. 63/185,473, filed on May 7, 2021.

(51) Int. Cl. H01M 10/0525; H01M 10/058; H01M 50/102; H01M 10/613

(52) U.S. Cl. CPC H01M 10/0525; H01M 10/058; H01M 50/102; H01M 10/613; H01M 2220/20

(57) ABSTRACT

A Square V cube battery comprising a container filled with a quantity of lithium-ion paste. The container is closed at either end by end caps. A plurality of metal partitions each having an upper and lower surface are disposed through-out the quantity of lithium-ion paste. The plurality of metal partitions spread recharging current across the entire upper and lower surfaces of each and every partition to reduce current pressure, friction and heat, to minimal levels. Each of the plurality of metal partitions holds a quantity of electrons.

### RELATED APPLICATIONS

This Application relates to and incorporates U.S. Application Ser. No. 63/185,473 entitled New Battery Design for Electric Vehicles filed May 7, 2021 in it's entirety.

### TECHNICAL FIELD

The present invention relates to a device to improve the efficiency of an air conditioner and more particularly to an air conditioner using heat extraction with water so as to remove heat from the refrigerant.

### BACKGROUND OF THE INVENTION

As technology continues to evolve, there is a need to provide improved power sources, particularly battery modules, for such vehicles and other implementations. For example, micro-hybrid battery modules may be constructed using a 12V lead acid battery and a 48V lithium ion battery. Micro-hybrid battery modules contribute a relatively large amount of weight to an xEV, which may ultimately lead to decreased fuel economy. Generally, lithium ion battery modules weigh less and have a better charge acceptance than lead acid battery modules despite being equipped with devices that control charge, control cooling, and so forth. It is now recognized that it may be desirable to simplify lithium ion battery modules, specifically those in micro-hybrid applications to improve overall vehicle performance.

### SUMMARY OF THE INVENTION

The present invention is directed to a Square V cube battery construction, as shown in FIG. 1. This design addresses at least some of the inherent problems encountered when working with Lithium-Ion paste, which is a thick, viscous semi-solid material that has a very high storage density of electrons per kilogram of paste.

When electrons fow through motors, magnetic fields within the motors are pushed by the electrons, causing rotational horsepower that turn the wheels of the electric vehicle (EV).

Lithium-Ion paste can hold large quantities of electrons. When electrons move through a motor, work results.

A constant (direct) electric charge (recharging), replaces the electrons used up to produce work, and the battery (multiple quantities of Lithium-Ion paste) is ready to send more electrons to the motors. Electric Vehicles that use one of the forms Lithium-Ion paste for energy (electron) storage, require large amounts of energy storge. Even a small E.V. can require. For every hour of operation, what the average house uses in two or three days of operation.

In order to shorten the amount of time needed to recharge a typical Lithium-Ion paste battery, greater amounts of electrons are forced through the Lithium-Ion paste. The very dense paste resists this pressure and friction between molecules results in a build up of heat, which quickly damages the paste unless the recharging rate reduces significantly. Water baths and extended recharging times have been the answer.

According to the present invention, four Square V cubes are stacked together to form a Four Square sub-assembly, and four sub-assemblies together comprise a sixteen cube cell, with ten cells completing the battery.

Further according to the present invention, a Square V cube battery comprising a container filled with a quantity of lithium-ion paste. The container is closed at either end by end caps. A plurality of metal partitions each having an upper and lower surface are disposed through-out the quantity of lithium-ion paste. The plurality of metal partitions spread re-charging current across the entire upper and lower surfaces of each and every partition to reduce current pressure, friction and heat, to minimal levels. Each of the plurality of metal partitions holds a quantity of electrons.

Still further according to the present invention, a Square V Dually, comprises a plastic container containing first and second Square V cubes. The first Square V cube contains a first quantity of lithium-ion paste. The second first Square V cube contains a second quantity of lithium-ion paste. The plastic container closed at either end by first and second end caps. The first Square V cube contains a first plurality of metal partitions each having an upper and lower surface disposed through-out the first quantity of lithium-ion paste. The second Square V cube contains a second plurality of metal partitions each having an upper and lower surface disposed through-out the second quantity of lithium-ion paste. The first plurality of metal partitions spread recharging current across the entire upper and lower surfaces of each and every partition to reduce current pressure, friction and heat in the first Square V cube to minimal levels. The second plurality of metal partitions spreading re-charging current across the entire upper and lower surfaces of each and every partition to reduce current pressure, friction and heat in the second Square V cube to minimal levels. Each of the first and second plurality of metal partitions holding a quantity of electrons.

### BRIEF DESCRIPTION OF THE DRAWING

The structure, operation, and advantages of the present invention will become further apparent upon consideration of the following description taken in conjunction with the accompanying figures (Figs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 shows a Square V cube battery construction, in accordance with the present invention.

FIG. 2 shows the end cap of a Four Square battery sub-assembly with a cathode end formed of a carbon coated copper foil and an anode end formed of a carbon coated aluminum foil in accordance with the present invention.

FIG. 3 shows a Four Square battery sub-assembly showing the metal partitions, in accordance with the present invention.

FIG. 4 shows a 16 cube cell, in accordance with the present invention.

FIG. 5 shows a Square V Dually which combines two Square V Cubes, in accordance with the present invention.

FIG. 6 shows the end cap of a Square V Dually, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader and should not in any way be interpreted as limiting.

### Description of Parts

Square V cube_Container is recycled plastic. Square population of Lithium-Ion paste in center, and six partitions of recycled aluminum. The depth of the cube is variable depending on the size of the battery desired. Air channels inherent in the design removes heat produced from friction.

Lithium-Ion paste_semi-solid metallic material that has a very high capacity to store electrons, as well as a low ability to hold onto them. It is the flow of electrons that allow work to be done.

Metal partitions_Six metal partitions in each population of Lithium-Ion paste, and ten surfaces that disperse re-charging electrons through out the paste, as well as holding large numbers of electrons onto each surface, to increase the capacity of every Square V cube that comprises the battery.

Container is made of recycled plastic, with sealed center area to retain semi-solid Lithium-Ion paste, with air channels surrounding the paste to remove any heat build-up.

End caps made from recycled plastic six millimeters thick.

A first end cap forms the Anode end which takes the electrons coming from the charging device. A metal sheet can be used for the Anode end. The metal sheet in the Anode end should contain some percent of copper, which raises the melting point to accept more electrons.

A second end cap used for the Cathode end is needed. But the electron flow is much slower so any thin metal sheet can be used for the Cathode end, as long as the metal sheet touches the ends of all the metal partitions.

Screws (4) drilled through the outside of each end cap and end in the body of cube itself and holds the paste inside. This leaves only the end of the metal sheet accessible so that an electrical line can be soldered in place.

The thin metal sheet used in the end caps for the Square V cube dually in FIG. 6 may look different, but the same concepts apply. The Anode end needs metal with a little copper in the recycled metal, but the number of electrons moving per second has to be shared with two populations of semi-solid, Lithium-Ion paste. A simple test will determine how many watts of electricity can be sent each minute before heat adversely affects the Lithium-ion paste.

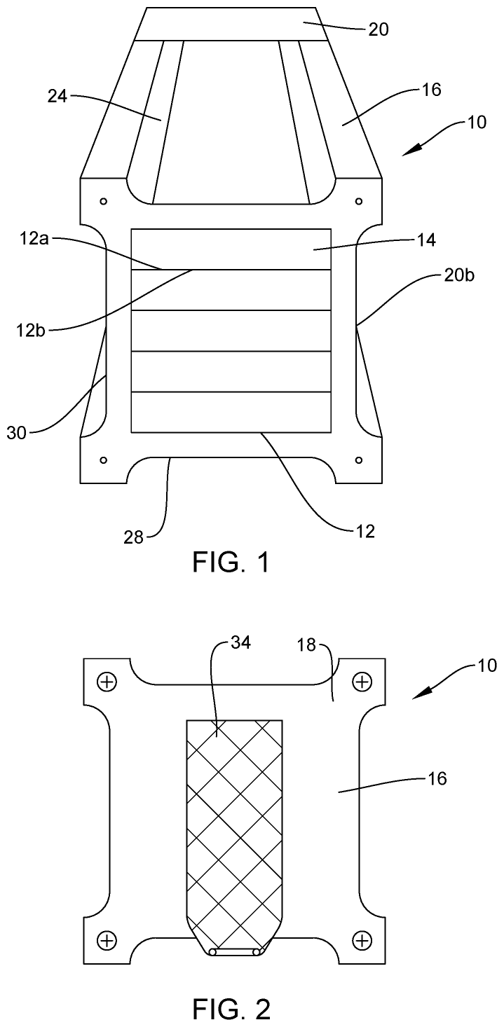

The basic building block of one embodiment of the battery of the present invention, as shown in FIG. 1 is called the Square V cube.

As shown in FIG. 1, the Square V cube battery 10 requires no water cooling system, because the heat buildup during re-charging is much less. This is accomplished by positioning metal partitions 12 through-out each quantity 14 of lithium-ion paste. Each partition 12 spreads the re-charging current across the entire upper and lower surface 12a and 12b, respectively, of each and every partition, effectively reducing current pressure, friction and heat, to minimal levels. In addition, each partition 12 will hold a quantity of electrons, and there are ten surface areas touching the paste that will add important quantities of capacity to every Square V cube battery 10.

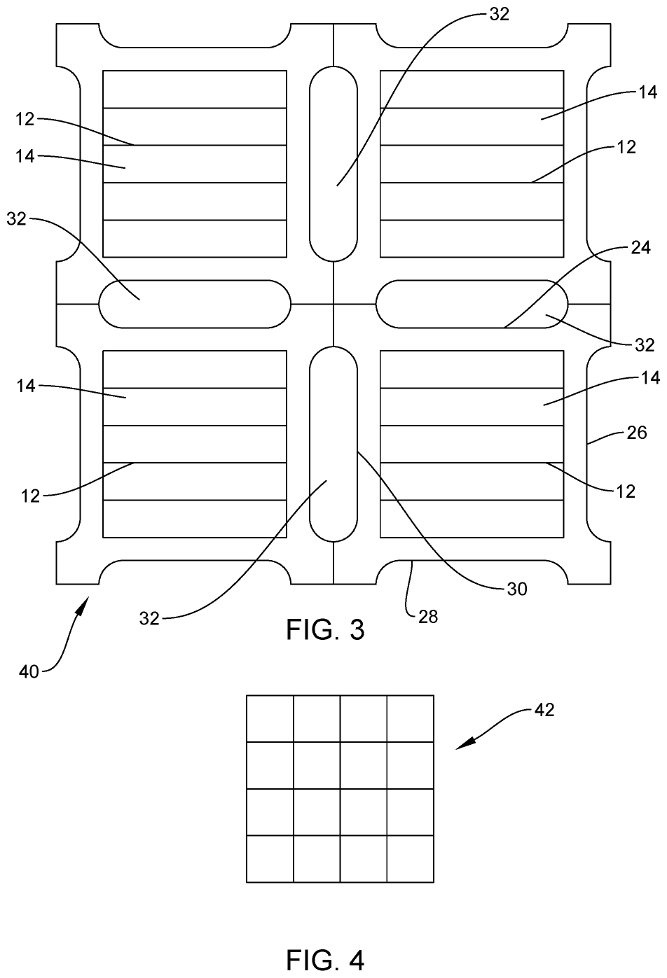

Another design feature of each Square V cube battery 10 is the use of recycled materials. Recycled plastic is used for the container 16, as well as recycled metals for both the Anode and Cathode end-caps 18 and 20, respectively, as well as the partitions 12, making each Square V cube's carbon footprint almost neutral. Also notice that the outside edge of each cube has a recessed area 24, 26, 28, 30 (24-30). Theses cut-outs 24-30, when placed together as shown in FIG. 3, form air channels 32 for ventilation, if needed.

End caps 18 and 20, as shown in FIGS. 1 and 2, are made from recycled plastic. Each end cap 18 and 20, has a thin metal strip 34 that transfers the re-charging electrons coming from the Anode end 18, to the metal partitions 12, each of which distributes the flow of electrons to the quantity 14 of Lithium-Ion paste. When work needs to be done, the electrons stored within the Lithium-Ion paste and partitions 12, move to the cathode end 20, where another metal strip, that is connected to a motor that will rotate to produce work.

Referring to FIG. 3, there is illustrated a four square sub-assembly 40, showing the metal partitions, the quantities of Lithium-Ion paste, and numerous air vents. Four of these sub-assemblies 40, as shown in FIG. 4, would comprise a sixteen cube cell 42, and ten to twenty cells could be wired together to form a battery. Note that the end caps, metal strips and electrical wiring has been omitted for clarity.

Referring to FIG. 3, there is illustrated a Square V Dually 50 which combines two

Square V cubes 10 into one recycled plastic container 52. This doubles the electrical capacity while simplifying the number of electrical connections needed to complete a battery. The number of Duallys' 50 required depends upon the capacity of the battery required, and the depth of the container 52, just like it does with the cube. Every 52 millimeters of depth should hold one half kilo of the Lithium Ion paste (double the amount for each dually) in each cube. For example, a sixteen cube cell would contain eight kilos of paste.

An advantage of using sets of Duallys 50 to produce a battery is that the watts used per minute when recharging can be at least doubled before heat build-up in the battery forcers a reduction in the recharge rate.

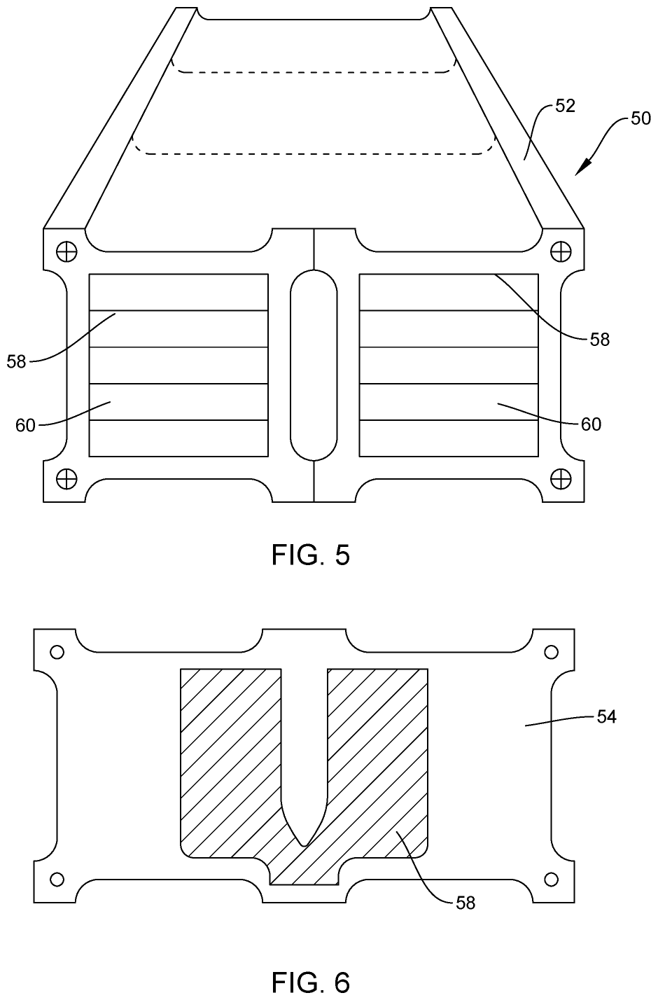

The Square V Dually 50, as shown in FIG. 5 incorporates an anode end cap 54 and a cathode end cap 56 (not shown) made from recycled plastic. A thin, recycled metal strip 58 adheres to the inside surface of the anode and cathode end caps 54 and 56. The metal strips 58 which are adhered to the inside surface of the anode and cathode end caps 54 and 56 is designed to stay in contact with the ends of all metal partitions 58 in both groups 60 and 62 of Lithium-Ion paste. The bottom edge of the metal strips 58 extends below the plastic of the end cap, into an air channel, for the attachment of an electrical line.

The anode end of the end cap 54 uses metal containing some copper for metal strip 58. The cathode end of the end cap 56 are formed of blended pieces aluminum. To avoid catastrophes, electrons should only flow from the charging station, to the anode, to the paste, to the cathode, and to the motor.

The volume of lithium-ion paste is determined by the cube's length. For example, a cube 10 in FIG. 1:

The exterior of each cube 10 is constructed of recycled plastic. The cubes 10 are designed to be stacked together as shown in FIG. 3. Four Square V cubes are stacked together to form a Four Square cube sub-assembly as shown in FIG. 3. A construction of 4 sub-assemblies comprises a 16 cube cell as shown in FIG. 2. A battery is constructed with an assembly of ten (10) 16 square v cubes.

As shown in FIG. 2, the end cap 18 of a cell 10 can include a metal foil 34 to make a good connection with another electrical connector.

Each cube 10 of the cell contains five (5) metal shelves 12, as shown in FIG. 1, which can be constructed of recycled metal. The shelves 12 along with the square design of each cube results in several benefits. The shelves carry electrical current, distributing electrons throughout the lithium-ion paste faster, because the distance the electrons must travel to recharge the lithium-ion paste is reduced.

The surface area of the metal shelves 12 reduces the time required to complete the electron flow during recharging.

The surface area of the shelves 12 reduces the heat generated during recharging as well as during the discharge flow.

The surface area of the shelves 12 increase the physical amount of electron storage, adding up to about fifty percent (50%) to the battery's capacity.

Each of the metal shelves 12 in the cubes 10 distributes the electron flow more evenly.

This reduces the extra time that is normally required to complete the electron flow when batteries have reached 90% of charge capacity, as well as speeding up the electron flow when the battery has less than 20% of capacity. This allows recharging percent to change from 60% without excessive time delays to 75% or higher.

The square design maximizes the volume of lithium-ion paste.

Higher recharging rates can be used without generating excess heat.

The square design of the cube cells 10 reduces the amount of heat generated (friction) during the charging and discharge. However, cavities for airflow, or even water filled tubes can be incorporated in the design of the cube cells to remove excess heat. This excess heat may come from the higher recharge wattage being used to reduce the intolerably long recharge times. The greater the wattage, the greater the heat that is generated.

The present invention has been described in detail above with reference to the embodiments of the drawings, and various modifications of the present invention can be made by those skilled in the art in light of the above description. Any modification within the spirit and principle of the present invention, made, equivalent substitutions, improvements, etc., should be included within the scope of the present invention. Thus, certain details of the embodiments should not be construed as limiting the present invention, the present invention will define the scope of the claims appended as the scope of the present invention.

1. A Square V cube battery comprising:
a container filled with a quantity of lithium-ion paste;
the container closed at either end by end caps.
a plurality of metal partitions each having an upper and lower surface disposed through-out the quantity of lithium-ion paste;
the plurality of metal partitions spreading re-charging current across the entire upper and lower surfaces of each and every partition to reduce current pressure, friction and heat, to minimal levels; and
each of the plurality of metal partitions holding a quantity of electrons.

2. The Square V cube battery of claim 1 wherein the Square V cube battery is constructed of recycled materials.

3. The Square V cube battery of claim 1 wherein the container is constructed of plastic.

4. The Square V cube battery of claim 1 wherein the container is closed at one end by an Anode end-cap and at the other end by a Cathode end-cap.

5. The Square V cube battery of claim 1 wherein the outside edge of each cube has a recessed area to form air channels for ventilation.

6. The Square V cube battery of claim 1 wherein the Anode end cap has a thin metal strip attached thereto that transfers the re-charging electrons coming from the Anode end cap to the metal partitions, each of which distributes the flow of electrons to the quantity of Lithium-Ion paste.

7. The Square V cube battery of claim 1 wherein the Cathode end cap has a thin metal strip attached thereto that transfers the electrons stored within the Lithium-Ion paste and the partitions that move to the cathode end cap to produce work.

8. The Square V cube battery of claim 1 wherein the metal partitions form ten surface areas touching the paste that will add important quantities of capacity to every Square V cube battery.

9. A Square V Dually, comprising:
a plastic container containing first and second Square V cubes;
the first Square V cube containing a first quantity of lithium-ion paste;
the second first Square V cube containing a second quantity of lithium-ion paste;
the plastic container closed at either end by first and second end caps;
the first Square V cube containing a first plurality of metal partitions each having an upper and lower surface disposed through-out the first quantity of lithium-ion paste;
the second Square V cube containing a second plurality of metal partitions each having an upper and lower surface disposed through-out the second quantity of lithium-ion paste;
the first plurality of metal partitions spreading re-charging current across the entire upper and lower surfaces of each and every partition to reduce current pressure, friction and heat in the first Square V cube to minimal levels;
the second plurality of metal partitions spreading re-charging current across the entire upper and lower surfaces of each and every partition to reduce current pressure, friction and heat in the second Square V cube to minimal levels; and
each of the first and second plurality of metal partitions holding a quantity of electrons.

10. The Square V Dually of claim 9 wherein the first end cap is an anode end cap and the second end cap is a cathode end cap.

11. The Square V Dually of claim 10 wherein a first thin, metal strip adheres to the inside surface of the anode end cap and a second thin metal strip adheres to the inside surface of the cathode end cap.

12. The Square V Dually of claim 11 wherein the first thin metal strip is in contact with the ends of the first and second plurality metal partitions adjacent the anode end cap.

13. The Square V Dually of claim 12 wherein the second thin metal strip is in contact with the ends of the first and second plurality metal partitions adjacent the cathode end cap.

14. The Square V Dually of claim 13 wherein a first bottom edge of the first metal strip and a second bottom edge of the second metal strip extends below the inside surface of the anode end cap and the cathode end cap.

15. The Square V Dually of claim 14 wherein a first bottom edge of the first metal strip and a second bottom edge of the second metal strip extends below the inside surface of the anode end cap and the cathode end cap into an air channel formed on an outside surface of the container.

16. The Square V Dually of claim 15 wherein the Square V cube battery is constructed of recycled materials.

17. The Square V Dually battery of claim 16 wherein the container is constructed of recycled plastic.

18. The Square V Dually battery of claim 17 wherein an outside surface of the container has a plurality of recessed areas to form air channels for ventilation.

19. The Square V Dually battery of claim 10 wherein the Anode end cap has a thin metal strip attached thereto that transfers the re-charging electrons coming from the Anode end cap to the first and second plurality of metal partitions, each of which distributes the flow of electrons to the first and second quantity of Lithium-Ion paste.

20. The Square V Dually battery of claim 20 wherein the Cathode end cap has a thin metal strip attached thereto that transfers the electrons stored within the first and second quantity of Lithium-Ion paste and the first and second plurality of metal partitions that move to the cathode end cap to produce work.
